(19) United States
(12) Patent Application Publication
(10) Pub. No.: US 2024/0067578 A1
(43) Pub. Date: Feb. 29, 2024

(54) SACRIFICIAL YARNS FOR USE IN CERAMIC MATRIX COMPOSITES, METHODS OF MANUFACTURE THEREOF AND ARTICLES COMPRISING THE SAME

(71) Applicant: Raytheon Technologies Corporation, Farmington, CT (US)

(72) Inventors: Zachary P. Konopaske, West Hartford, CT (US); Robin H. Fernandez, East Haddam, CT (US); John D. Riehl, Hebron, CT (US); Kathryn S. Read, Marlborough, CT (US); Steven R. Clarke, Mansfield, MA (US); Aaron Tomich, Sutton, MA (US)

(21) Appl. No.: 18/083,976

(22) Filed: Dec. 19, 2022

Related U.S. Application Data
(60) Provisional application No. 63/291,863, filed on Dec. 20, 2021.

(51) Int. Cl. C04B 38/06; C04B 20/00; C04B 35/565; C04B 35/80; C22C 47/06; C22C 49/14

(52) U.S. Cl. CPC C04B 38/06; C04B 20/0068; C04B 35/565; C04B 35/80; C22C 47/066; C22C 49/14; C04B 2235/5212; C04B 2235/5224; C04B 2235/5244; C04B 2235/614

(57) ABSTRACT

Disclosed herein is a composite co-fiber comprising a plurality of ceramic tows; one or more sacrificial yarns; where the sacrificial yarns are operative to undergo dissolution, decomposition or melting upon being subjected to an elevated temperature; and wherein the sacrificial yarns leave open spaces in the co-fiber upon being subjected to decomposition, dissolution or melting.

### CROSS-REFERENCE TO RELATED APPLICATIONS

This application claims the benefit of U.S. Provisional Application Ser. No. 63/291,863 filed Dec. 20, 2021, which is incorporated herein by reference in its entirety.

### BACKGROUND

This disclosure relates to sacrificial yarns for use in ceramic matrix composites, methods of manufacture thereof and articles comprising the same.

Preforms are used for the fabrication of ceramic matrix composite (CMC) structures using chemical vapor infiltration (CVI), polymer infiltration pyrolysis (PIP) and melt infiltration (MI). A preform can include fibers, which can be unidirectional or woven (e.g. plain weave, 5 Harness Satin Weave, 8 Harness Satin Weave, twill) or braided. In one form the fibers can be ceramic based and can be formed of silicon carbide (SiC). Within the reaction chamber at an elevated temperature the preform can be exposed to certain gasses. On being exposed to the certain gasses at an elevated temperature, a reaction can occur resulting in the deposition of a ceramic on the fibers of the preform.

Chemical vapor infiltration (CVI) is a process whereby matrix material is infiltrated into fibrous preforms by the use of reactive gases at elevated temperature to form fiber-reinforced composites. CVI can be applied to the production of ceramic-matrix composites. CMCs can potentially be used at temperatures of up to and greater than 2700° F. Polymer infiltration pyrolysis (PIP) comprises the infiltration of a low viscosity polymer into the fiber structure, followed by pyrolysis. Under pyrolysis, the polymer precursor is heated in an inert atmosphere and transformed into a ceramic due to its decomposition. Melt infiltration is based on the infiltration of porous matrices with the melt of an active phase or precursor.

One of the key limitations of a CMC structure is that the structure can contain significant porosity (e.g., up to 15% and more) which is typically greatest in the center of the CMC structure and which can increase with an increasing thickness of the preform. The porosity can increase with thickness and can significantly impact both the in-plane and inter-laminar properties and overall oxidation resistance of the composite.

During chemical vapor infiltration, the ceramic precursor vapors react preferentially on the outer plies. This higher rate of reaction on the outermost plies prevents ingress of subsequent vapors into the center of the ceramic matrix composite. The inability to infiltrate the central portion of the matrix produces voids in the center of the matrix. It is preferable to design composites where such density differences do not occur and where voids are absent thus providing the composite with a longer life span.

### SUMMARY

Disclosed herein is a composite co-fiber comprising a plurality of ceramic tows; one or more sacrificial yarns; where the sacrificial yarns are operative to undergo dissolution, decomposition or melting upon being subjected to an elevated temperature; and wherein the sacrificial yarns leave open spaces in the co-fiber upon being subjected to decomposition, dissolution or melting.

In an embodiment, the ceramic tows comprise SiC, Al₂O₃, BN, B₄C, Si₃N₄, MoSi₂, SiO₂, SiOC, SiNC, and/or SiONC.

In another embodiment, the sacrificial yarns comprise metal fibers, ceramic fibers, polymeric fibers or a combination thereof.

In yet another embodiment, the metal fibers and ceramic fibers melt at temperatures of less than 500° C.

In yet another embodiment, the polymeric fibers comprise thermoplastic polymers, blend of thermoplastic polymers, thermosetting polymers, or blends of thermoplastic polymers with thermosetting polymers.

In yet another embodiment, the sacrificial yarn is present in the composite co-fiber in an amount of greater than or equal to 20 wt %, based on a total weight of the composite co-fiber.

In yet another embodiment, the sacrificial yarn is present in the composite co-fiber in an amount of greater than or equal to 35 wt %, based on a total weight of the composite co-fiber.

In yet another embodiment, the sacrificial yarn is present in the composite co-fiber in an amount effective to create a percolating volume fraction.

In yet another embodiment, the sacrificial yarn is present in a larger amount at an outer periphery of the composite co-fiber relative to the amount present in a center of the composite co-fiber.

In yet another embodiment, the sacrificial yarn comprises a water soluble polymer.

In yet another embodiment, the sacrificial yarn comprises polyvinyl alcohol, polyacrylamide, or a combination thereof.

In an embodiment, an article manufactured from the composite co-fiber.

In an embodiment, the article is a space filling insert.

In an embodiment, the space filling insert is used in a turbine component.

Disclosed herein is a method of manufacturing a ceramic matrix composite comprising co-braiding a sacrificial yarn with a ceramic tow to form the composite co-fiber; melting, dissolving or decomposing the sacrificial yarn to form a space in the composite co-fiber; and infiltrating the space with a ceramic precursor to form a ceramic matrix.

In an embodiment, the sacrificial yarn comprises thermoplastic polymers, blend of thermoplastic polymers, thermosetting polymers, or blends of thermoplastic polymers with thermosetting polymers.

In an embodiment, the ceramic matrix comprises SiC.

In yet an embodiment, the ceramic tow comprises SiC.

In an embodiment, the ceramic precursor with itself to form the ceramic matrix.

In an embodiment, the co-braiding is conducted to produce a space filling insert.

### BRIEF DESCRIPTION OF THE DRAWINGS

Referring now to the figures, which are exemplary embodiments, and wherein the like elements are numbered alike:

FIG. 1 is a prior art depiction of a cross-section of a conventional fiber prior to and after infiltration; and

FIG. 2 is a depiction of an exemplary cross-section of a composite co-fiber with sacrificial yarn prior to and after infiltration;

FIG. 3A is a depiction of an exemplary cross section of a composite co-fiber comprising ceramic tows and sacrificial yarns in a random arrangement;

FIG. 3B is a depiction of an exemplary cross section of a composite co-fiber comprising ceramic tows and sacrificial yarns in an organized arrangement that facilitates vapor ingression during chemical vapor infiltration;

FIG. 3C is a depiction of another exemplary cross section of a composite co-fiber comprising ceramic tows and sacrificial yarns in an organized arrangement that facilitates vapor ingression during chemical vapor infiltration; and

FIG. 4 is an exemplary depiction of a simplified perspective view of a preform structure with a triangular insert shown in close-up.

### DETAILED DESCRIPTION

A detailed description of one or more embodiments of the disclosed apparatus and method are presented herein by way of exemplification and not limitation with reference to the Figures.

Disclosed herein is a ceramic composite matrix that comprises composite co-fibers that initially (prior to densification by a ceramic precursor) comprise ceramic tows and sacrificial yarns. The co-fiber comprises ceramic tows co-braided or co-woven with polymeric yarns (herein after sacrificial yarns). In an embodiment, the co-fiber can form a space filler or noodle for use in a component such as a turbine blade. Space fillers and noodles (also referred to herein as inserts) will be described in detail later.

The sacrificial yarns undergo decomposition either prior to or during a precursor deposition process opening up spaces between the ceramic tows in the composite co-fiber. These open spaces permit the flow of vapors or liquids during an infiltration process (e.g., infiltration of precursor vapors or liquids such as during CVI, PIP, MI, and the like) and permits the precursors to penetrate into and react in the interior of the composite. The ability of precursors to permeate the interior of the ceramic composite matrix reduces the formation of voids in the composite and facilitates the formation of a composite with more uniform properties.

In all of the methods listed above (CVI, PIP, MI, and the like), the open spaces in the preform close or reduce in space before the matrix material is fully infiltrated into the preform. This leaves voids in the interior of the preform, which results in regions of weakness (e.g., reduced interlaminar properties, reduced yield strength or reduced rupture strength) in the interior of the preform. A preform comprises a plurality of plies that are made by weaving together the co-fiber.

While this document uses terms such as woven or braided, it is to be noted that the co-fiber comprises assembling ceramic tows with sacrificial yarns. This assembling may be accomplished via spooling, twisting, weaving, braiding, comingling, and the like. All of these different methods of assembling the ceramic tow with the sacrificial yarn can accomplish the providing of open spaces for the ceramic precursor to enter into the preform during densification.

Precursor infiltration (especially during CVI) into the center of the composite is often restricted because the ceramic precursor vapors react preferentially on the outer surfaces of the composite. This higher rate of reaction on the outermost plies prevents ingress of subsequent precursor molecules into the center of the ceramic matrix composite. The inability to infiltrate the central portion of the matrix produces voids in the center of the matrix, which result in an increased porosity. The porosity can significantly impact both the in-plane and inter-laminar properties and overall oxidation resistance of the composite.

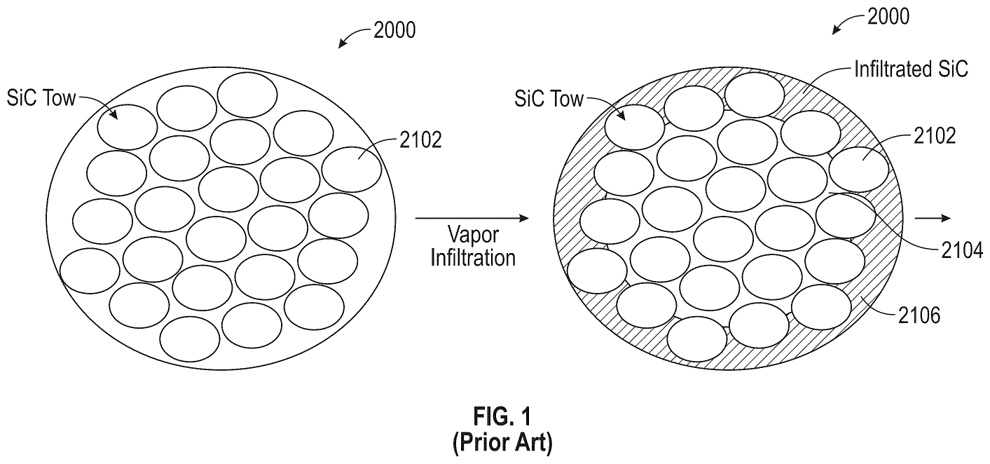

FIG. 1 depicts an exemplary embodiment of a prior art composite 2000 that undergoes vapor infiltration. The prior art composite 2000 without the matrix comprises a plurality of ceramic tows 2102 and is located on the left hand side of the arrow, while the composite 2000 after vapor infiltration is located on the right hand side of the arrow. These ceramic tows 2102 have melting points that are higher than the temperatures used in the precursor infiltration process and therefore do not melt during the infiltration. When the prior art composite 2000 is subjected to vapor infiltration, the vapors condense and react on a surface of the tow producing a filled portion 2106 while at the same time producing voids 2104 in the interior of the composite. These voids are undesirable. Since approximately 35% of the composite 2000 is filled with ceramic tows, there is a large volume of void space 2104, which is undesirable.

The ceramic tows 2102 comprises ceramic filaments (not shown). The filaments may be continuous or dis-continuous in nature. A ceramic tow typically comprises 300 to several thousand filaments, preferably 400 to 600 filaments. The diameter of a ceramic tow is therefore larger than that of a filament. The ceramic tows have an average cross-sectional diameter of 300 to 1500 micrometers, while the filaments have an average cross-sectional diameter of 5 to 15 micrometers. The cross-sectional area of a tow may be circular or flat. A plurality of ceramic tows embedded in a ceramic matrix is referred to herein as a composite.

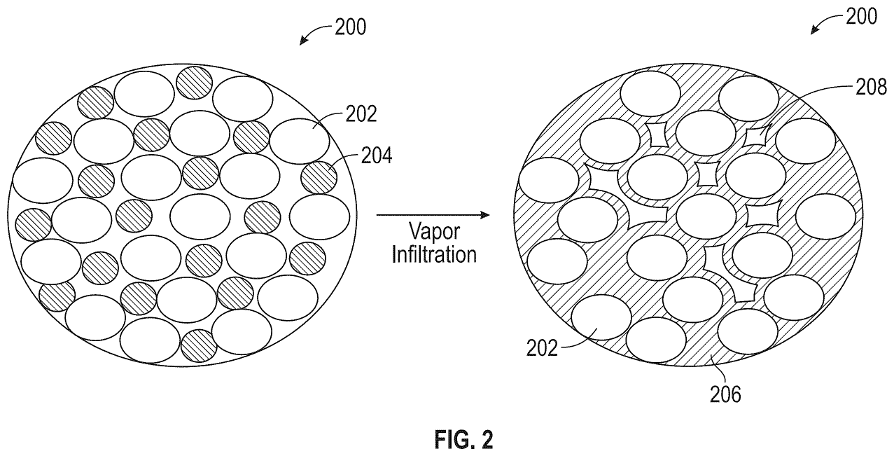

Incorporating sacrificial yarns enables further control over the matrix density in the composite. A sacrificial yarn is made up of fibers that melt, dissolve or thermally decompose upon exposure to high temperatures. Yarns may be made up of metal fibers, ceramic fibers, polymeric fibers or a combination thereof. FIG. 2 depicts an embodiment wherein a composite co-fiber 200 comprises both ceramic tows 202 and a sacrificial yarn 204. The sacrificial yarn 204 is inserted between the ceramic tows of the composite to create the composite co-fiber 200. The composite co-fibers 200 containing the ceramic tows 202 and the sacrificial yarn 204 is subjected to a precursor infiltration process. A preferred precursor infiltration process is a chemical vapor infiltration process.

During the precursor infiltration process, the composite co-fiber 200 is subjected to a high temperature (a temperature that is greater than either the melting point of the sacrificial yarn or greater than the decomposition temperature of the sacrificial yarn) causing the sacrificial yarn to melt away or to decompose and evaporate. This elevated temperature exposure occurs prior to infiltration of the precursor used to form the matrix material. After the decomposition of the sacrificial yarn occurs, a space is left behind where the yarn previously was. This space is infiltrated by the vapors that eventually form the matrix material in the ceramic matrix composite. FIG. 2 depicts a cross-section of the fiber 200 where the sacrificial yarn 204 has decomposed, leaving more room for the vapors to infiltrate the center of the fiber 200 and form the ceramic matrix 206. The sacrificial yarn decomposes, such that the space it previously occupied may be filled with the matrix material. From the FIG. 2, it may be seen that the fiber 200 is further infiltrated with the ceramic matrix material 206, shown as the shaded area. The void space 208 in the FIG. 2 is much smaller than the void space seen in the FIG. 1.

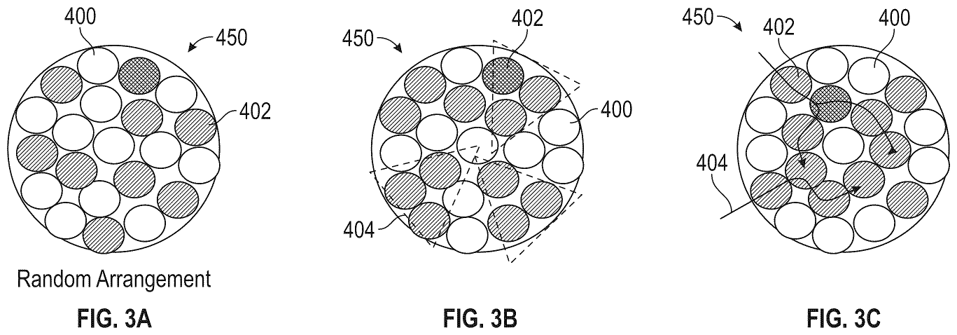

The sacrificial yarn can be woven or braided with the ceramic tow to form the composite co-fiber. The sacrificial yarns in the composite co-fiber may be arranged randomly or specifically arranged in a manner to facilitate precursor infiltration during the infiltration process. FIGS. 3A, 3B and 3C are cross-sectional depictions of various arrangements of the tows in a composite co-fiber 450. FIG. 3A depicts a random arrangement of sacrificial yarns 402 in the composite co-fiber 450. In the FIG. 3A, the sacrificial fibers 402 are randomly arranged amongst the ceramic fibers 400. Such an arrangement permits the inflow of precursor vapors but is not the most efficient arrangement for creating spaces and filling them with a matrix material.

FIGS. 3B and 3C are arrangements where the sacrificial yarns 402 are arranged to permit efficient fiber degradation followed by efficient ingress of the precursor vapors. In the FIG. 3B, there are a larger number of sacrificial yarns 402 arranged on the outer periphery of the composite co-fiber 450 when compared with the number of sacrificial yarns 402 arranged in the interior of the composite co-fiber 450. The arrangement of a cluster of the sacrificial yarns 402 roughly approximates a slice of a pie 404. Each composite co-fiber 450 may comprise one or more such pie shaped arrangements, preferably two or more such pie shaped arrangements. In other words, the sacrificial yarn is present in a larger amount at an outer periphery of the composite co-fiber relative to the amount present in a center of the composite co-fiber. Since there are a larger number of sacrificial yarns 402 arranged on the outside of the composite co-fiber 450 larger spaces for vapor ingression are created on the outside of the composite co-fiber—this permits larger regions for vapor ingression into the outer periphery of the composite co-fiber 450 from which it can diffuse into the inner regions of the composite co-fiber 450.

FIG. 3C depicts another exemplary embodiment where the sacrificial yarns are arranged in such a manner that pathways are created through the composite co-fiber 450 so that there is limited resistance to the ingress of vapors into the center of the tow. In the FIG. 3C, a plurality of sacrificial yarns 402 are arranged to be in continual contact with one another to allow for vapor ingression along path 404 through the composite co-fiber 410 when the sacrificial yarns are removed. In other words, in the FIG. 3C the sacrificial yarns 402 are arranged to contact each other at their respective outer peripheries to create a percolating network.

The arrangement of the sacrificial yarns in the composite co-fiber facilitates vapor ingression during the chemical vapor infiltration process. In an embodiment, the sacrificial yarns occupy at least 30% of the cross-sectional area of the fiber, preferably at least 40% of the cross-sectional area of the fiber, and more preferably at least 50% of the cross-sectional area of the fiber.

After the decomposition of the sacrificial yarn, the vapors generated during precursor infiltration encounter a less resistance to penetrating the space between the innermost tows and thus condense more uniformly throughout the preform. This results in a more uniform distribution of matrix material through preform. Put another way, by using yarns that decomposition upon high thermal exposure, additional pathways to the ingress of precursors which results in a uniform distribution of matrix material. This prevents the formation of heterogenous zones that contain voids in the central region of the ceramic matrix composite. It also prevents the formation of regions that have a lower concentration of the ceramic material when compared with regions near the outer surface of the ceramic matrix composite.

The sacrificial yarn can include metal fibers, ceramic fibers or polymeric fibers. The metal fibers and ceramic fibers are typically low melting fibers that melt at temperatures of 500° C. or less. They are mixed with the desired ceramic tows to form the composite co-fiber. The metal or ceramic fibers generally melt and drip away from the composite co-fiber leaving behind only the desired ceramic tows with spaces in between the tows. The ceramic precursor vapors diffuse into the spaces to form the matrix.

Metal fibers that have low melting points are listed in the Table below. Alloys of two or more of bismuth, indium, tin, thallium, cadmium and lead may be used.

| | Melting |
|---|---|
| Metal or Alloy name | point (° C.) |
| Bismuth | 271 |
| Indium | 157 |
| Tin | 232 |
| Thallium | 304 |
| Cadmium | 321 |
| Lead | 327 |
| Cerrobend | 70 |
| Cerrolow 117 | 47 |
| Cerrolow 174 | 79 |
| Field's | 62 |
| Harper's | 75 |
| Lichtenberg's | 92 |
| Lipowitz | 80 |
| Newton's | 98 |

Polymeric fibers undergo decomposition at temperatures of over 300° C. It is desirable for the polymeric fibers to be low charring fibers, i.e., they produce little to no char upon undergoing decomposition. The polymeric fibers can also be removed by dissolution in a solvent. Suitable solvents are water, ethanol, or a combination thereof.

Organic polymers used in the sacrificial yarns can be from a wide variety of thermoplastic polymers, blend of thermoplastic polymers, thermosetting polymers, or blends of thermoplastic polymers with thermosetting polymers. The organic polymer may also be a blend of polymers, copolymers, terpolymers, or combinations comprising at least one of the foregoing organic polymers. The organic polymer can also be an oligomer, a homopolymer, a copolymer, a block copolymer, an alternating block copolymer, a random polymer, a random copolymer, a random block copolymer, a graft copolymer, a star block copolymer, a dendrimer, a polyelectrolyte (polymers that have some repeat groups that contain electrolytes), a polyampholyte (a polyelectrolyte having both cationic and anionic repeat groups), an ionomer, or the like, or a combination comprising at last one of the foregoing organic polymers. The organic polymers have number average molecular weights greater than 10,000 grams per mole, preferably greater than 20,000 g/mole and more preferably greater than 50,000 g/mole.

Examples of thermoplastic polymers that can be used in the polymeric material include polyacetals, polyacrylics, polycarbonates, polyalkyds, polystyrenes, polyolefins, polyesters, poly amides, polyaramides, polyamideimides, polyarylates, polyurethanes, epoxies, phenolics, silicones, polyarylsulfones, polyethersulfones, polyphenylene sulfides, polysulfones, polyimides, polyetherimides, polytetrafluoroethylenes, polyetherketones, polyether ether ketones, polyether ketone ketones, polybenzoxazoles, polyoxadiazoles, polybenzothiazinophenothiazines, polybenzothiazoles, polypyrazinoquinoxalines, polypyromellitimides, polyguinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, poly sulfonamides, polyureas, polyphosphazenes, polysilazanes, polypropylenes, polyethylenes, polyethylene terephthalates, polyvinylidene fluorides, polysiloxanes, or the like, or a combination thereof.

Water soluble polymers are desirable for use in the sacrificial yarns. Examples of preferred sacrificial yarns are polyvinyl alcohol, polyacrylamide, or a combination thereof. It is desirable for the sacrificial fibers to be low charring polymers that do not leave behind much of a residue upon decomposition.

Examples of polyelectrolytes are polystyrene sulfonic acid, polyacrylic acid, pectin, carrageenan, alginates, carboxymethylcellulose, polyvinylpyrrolidone, or the like, or a combination thereof.

Examples of thermosetting polymers suitable for use as hosts in emissive layer include epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or the like, or a combination thereof.

Examples of blends of thermoplastic polymers include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, poly carbonate/polyethylene terephthalate, polycarbonate/polybutylene terephthalate, thermoplastic elastomer alloys, nylon/elastomers, polyester/elastomers, polyethylene terephthalate/polybutylene terephthalate, acetal/elastomer, styrene-maleic anhydride/acrylonitrile-butadiene-styrene, poly ether etherketone/polyethersulfone, poly ether etherketone/polyetherimide polyethylene/nylon, polyethylene/polyacetal, or the like, or a combination thereof.

The sacrificial yarns can also include biodegradable materials. Suitable examples of biodegradable polymers are as polylactic-glycolic acid (PLGA), poly-caprolactone (PCL), copolymers of polylactic-glycolic acid and poly-caprolactone (PCL-PLGA copolymer), polyhydroxy-butyrate-valerate (PHBV), poly orthoester (POE), polyethylene oxide-butylene terephthalate (PEO-PBTP), poly-D,L-lactic acid-p-dioxanone-polyethylene glycol block copolymer (PLA-DX-PEG), or the like, or a combination thereof.

Exemplary sacrificial yarns are polyvinyl alcohol, polyacrylamide, polyamides, or a combination thereof.

The sacrificial yarn may be present in the composite co-fiber in an amount of greater than or equal to 20 wt %, preferably greater than or equal to 30 wt % and more preferably greater than or equal to 35 wt %, based on the total weight of the composite co-fiber prior to chemical vapor infiltration.

The fiber contains a ceramic tow in addition to the sacrificial yarn. Suitable ceramic tows comprise silicon carbide (SiC), alumina (Al₂O₃), mullite (Al₂O₃—SiO₂), or a combination thereof. In an embodiment, the tow may contain non-ceramic fibers. Other suitable fibers are carbon fibers. The ceramic matrix (that fills in the space between the fibers) comprises SiC, Al₂O₃, BN, B₄C, Si₃N₄, MoSi₂, SiO₂, SiOC, SiNC, and/or SiONC.

In one method of manufacturing a preform (that initially comprises a sacrificial yarn), a plurality of ceramic tows are braided with the sacrificial yarn into a composite co-fiber. The preform is then placed in a chemical vapor infiltration chamber where the temperature is raised over 500° C., preferably over 750° C. During this temperature increase, the sacrificial yarn undergoes degradation providing space in the fiber for the ceramic vapors to diffuse and react. The ceramic precursor vapors condense and react in the spaces thus filling in the spaces with a ceramic matrix. In an embodiment, the ceramic precursor vapors contact the tows and fill in the spaces to form the ceramic matrix composite.

The composite co-fibers containing the sacrificial yarn thus contain at least 20 volume percent (vol %) of additional ceramic matrix compared with composites that do not contain the sacrificial yarn prior to chemical vapor infiltration. In an embodiment, the composite co-fibers containing the sacrificial yarn thus contain at least 30 vol % of additional ceramic matrix compared with composites that do not contain the sacrificial yarn initially. In yet another embodiment, the composite co-fibers containing the sacrificial yarn thus contain at least 40 vol % of additional ceramic matrix compared with composites that do not contain the sacrificial yarn initially.

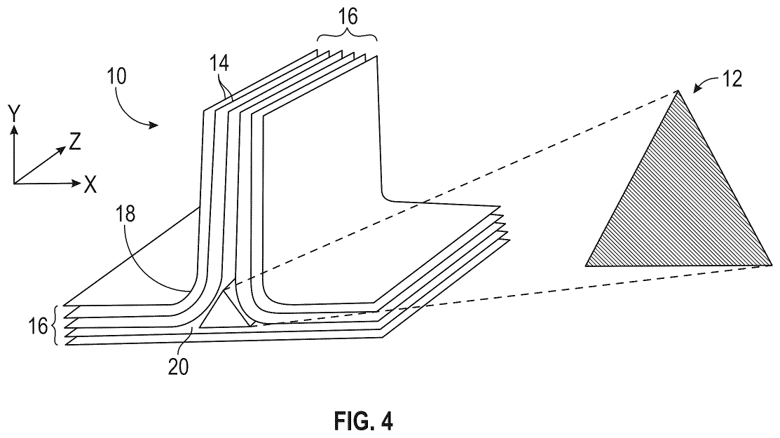

The composite co-fibers may be used in space filling applications such as noodles (triangular inserts) where it is difficult for vapors to reach. FIG. 4 is a simplified perspective view of a preform structure with a triangular insert shown in close-up. FIG. 4 is a simplified perspective view of preform 10 with an enlarged view of insert 12. Preform 10 can be used to form a CMC component for use in a gas turbine engine combustor, compressor, and/or turbine section, to name a few non-limiting examples. Preform 10 is formed from multiple plies 14 laid up in such a manner as to form a structure with a desired shape and thickness. The plies 14 are manufactured from normal plies that do not contain the sacrificial yarns. They contain only ceramic tows. Plies 14 can be formed from braided, woven, and/or chopped ceramic fibers or tows. The ceramic material can be silicon carbide or another suitable ceramic material. As shown in FIG. 4, plies 14 can be laid up to form walls 16 with curved regions 18. The bending of plies 14 to form curved region 18 can create a void 20 between a subset of plies 14. Void 20 can be too small to effectively fill with additional plies 14, and too large to fill with individual ceramic tows or tow bundles. Thus, insert 12 (also referred to herein as a space filling insert or a noodle) can be formed to have a shape and size generally complementary to void 20. More specifically, insert 12 can be formed to have a complementary triangular cross-sectional geometry, a thickness or width defined in one or a combination of the x and y-axes, and a length extending alone the z-axis. Generally speaking, insert 12 is sized to fill void 20 along the x, y, and z-axes.

Insert 12 can be formed from the composite co-fibers, as is discussed in greater detail below. Ceramic tows may be co-braided with tows of sacrificial yarns to form the insert 12 (also referred to as a space filler or noodle). Insert 12 can formed via braiding or 3D weaving where fiber components are woven in three, generally orthogonal (x, y, z) axes. A braid (also referred to as a plait) is a complex structure or pattern formed by interlacing two or more strands of flexible material such as textile yarns. In this particular embodiment, the ceramic tows and the sacrificial yarns are braided to form the insert 12. As with two-dimensional (2D) woven structures (e.g., plies 14), inset 12 can have warp and weft fibers, but can further include z-fibers orthogonal to and crossing over layers of warp and/or weft fibers. The warp and weft fibers can be manufactured from the composite co-fibers detailed above. In this embodiment, the sacrificial yarns can be decomposed (e.g., thermally or chemically) during subsequent processing to help locally control the fiber volume fraction/porosity of the insert, as these sacrificial yarns leave behind open spaces when decomposed.

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

What is claimed is:

1. A composite co-fiber comprising:
a plurality of ceramic tows;
one or more sacrificial yarns; where the sacrificial yarns are operative to undergo dissolution, decomposition or melting upon being subjected to an elevated temperature; and wherein the sacrificial yarns leave open spaces in the co-fiber upon being subjected to decomposition, dissolution or melting.

2. The composite co-fiber of claim 1, wherein the ceramic tows comprise SiC, Al₂O₃, BN, B₄C, Si₃N₄, MoSi₂, SiO₂, SiOC, SiNC, and/or SiONC.

3. The composite co-fiber of claim 1, wherein the sacrificial yarns comprise metal fibers, ceramic fibers, polymeric fibers or a combination thereof.

4. The composite co-fiber of claim 3, wherein the metal fibers and ceramic fibers melt or decompose at temperatures of less than 500° C.

5. The composite co-fiber of claim 3, wherein the polymeric fibers comprise thermoplastic polymers, blend of thermoplastic polymers, thermosetting polymers, or blends of thermoplastic polymers with thermosetting polymers.

6. The composite co-fiber of claim 1, wherein the sacrificial yarn is present in the composite co-fiber in an amount of greater than or equal to 20 wt %, based on a total weight of the composite co-fiber.

7. The composite co-fiber of claim 1, wherein the sacrificial yarn is present in the composite co-fiber in an amount of greater than or equal to 35 wt %, based on a total weight of the composite co-fiber.

8. The composite co-fiber of claim 1, wherein the sacrificial yarn is present in the composite co-fiber in an amount effective to create a percolating volume fraction.

9. The composite co-fiber of claim 1, wherein the sacrificial yarn is present in a larger amount at an outer periphery of the composite co-fiber relative to the amount present in a center of the composite co-fiber.

10. The composite co-fiber of claim 1, wherein the sacrificial yarn comprises a water soluble polymer.

11. The composite co-fiber of claim 1, wherein the sacrificial yarn comprises polyvinyl alcohol, polyacrylamide, or a combination thereof.

12. An article manufactured from the composite co-fiber of claim 1.

13. The article of claim 12, wherein the article is a space filling insert.

14. The article of claim 13, wherein the space filling insert is used in a turbine component.

15. A method of manufacturing a ceramic matrix composite comprising:
co-braiding a sacrificial yarn with a ceramic tow to form the composite co-fiber;
melting, dissolving or decomposing the sacrificial yarn to form a space in the composite co-fiber; and
infiltrating the space with a ceramic precursor to form a ceramic matrix.

16. The method of claim 15, wherein the sacrificial yarn comprises thermoplastic polymers, blend of thermoplastic polymers, thermosetting polymers, or blends of thermoplastic polymers with thermosetting polymers.

17. The method of claim 15, wherein the ceramic matrix comprises SiC.

18. The method of claim 17, wherein the ceramic tow comprises SiC.

19. The method of claim 15, further comprising reacting the ceramic precursor with itself to form the ceramic matrix.

20. The method of claim 15, wherein the co-braiding is conducted to produce a space filling insert.
